(19) United States
(12) Patent Application Publication
(10) Pub. No.: US 2009/0092819 A1
(43) Pub. Date: Apr. 9, 2009

(54) POROUS PRESSURE SENSITIVE ADHESIVE AND TAPES

(75) Inventors: Ranjit MALIK, York, PA (US); Kevin J. MCKINNEY, Seven Valleys, PA (US)

Correspondence Address: MCNEES WALLACE & NURICK LLC, 100 PINE STREET, P.O. BOX 1166, HARRISBURG, PA, 17108-1166, US

(73) Assignee: ADHESIVES RESEARCH, INC., Glen Rock, PA (US)

(21) Appl. No.: 12/247,621

(22) Filed: Oct. 8, 2008

Related U.S. Application Data
(60) Provisional application No. 60/978,591, filed on Oct. 9, 2007.

(51) Int. Cl. B32B 3/26; B32B 7/12

(52) U.S. Cl. 428/305.5; 428/304.4; 428/315.5; 264/419; 427/208.4; 428/345

(57) ABSTRACT

A pressure sensitive adhesive includes a substantially continuous polymer phase having pressure sensitive adhesive properties, and a plurality of pores arranged within the substantially continuous polymer phase and disposed to permit fluid to pass from a first side through at least a portion of the plurality of pores to a second side. The plurality of pores is substantially resistant to cold flow. A method of forming a porous pressure sensitive adhesive tape includes providing a solution for forming an adhesive having pressure sensitive adhesive properties, the solution including a pore forming material, casting a film comprising the solution, laminating a liner on the film, and exposing the adhesive to an energy source to form pores in the adhesive and cure the adhesive to form the pressure sensitive adhesive tape.

### CROSS-REFERENCE TO RELATED APPLICATIONS

This Application claims benefit of Provisional Application No. 60/978,591, filed Oct. 9, 2007. The disclosure of the Provisional Application is hereby incorporated by reference in its entirety.

### FIELD

The present disclosure is directed to pressure sensitive adhesives. In particular, the present disclosure is directed to porous pressure sensitive adhesives and tapes.

### BACKGROUND

Pressure sensitive adhesives are utilized for providing a bond to a substrate without the use of solvent, water, and/or heat to activate the adhesive. Applications for pressure sensitive adhesives include labels for power equipment, foil for duct work, automotive interior trim assembly, and sound/vibration damping films.

Porous pressure sensitive adhesives may permit fluids to travel through the pressure sensitive adhesive on an adhesive film or tape. Known systems for adhesive films and tapes have utilized systems and processes for pore formation that are complicated, expensive, and/or environmentally hazardous. For example, known systems for pore formation may include utilizing an acetone solution to produce pores and/or utilizing ovens at temperatures of about 130° C. (about 266° F.) and about 150° C. (about 302° F.). Over time, the pores of these known systems may destabilize. This destabilization results in adhesive flowing from the walls of the pores into the open area causing the pores to collapse

What is needed is an adhesive, a method of adhering, and a method of producing an adhesive, wherein the adhesive is able to be formed by including pressure sensitive adhesive on a substrate, with pores that substantially do not destabilize over time, do not require extended heating and/or baking to be cured, and/or do not require environmentally hazardous, complicated, or expensive processing.

### SUMMARY

An embodiment of the disclosure includes a pressure sensitive adhesive including a substantially continuous polymer phase having pressure sensitive adhesive properties, and a plurality of pores arranged within the substantially continuous polymer phase and disposed to permit fluid to pass from a first side through at least a portion of the plurality of pores to a second side. In the embodiment, the plurality of pores is substantially resistant to cold flow.

Another embodiment of the disclosure includes a method of forming a porous pressure sensitive adhesive tape including providing a solution for forming an adhesive having pressure sensitive adhesive properties, the solution including a pore forming material, casting a film comprising the solution, laminating a liner on the film, and exposing the adhesive to an energy source to form pores in the adhesive and cure the adhesive to form the pressure sensitive adhesive tape.

An advantage of the present disclosure includes pores in an adhesive permitting fluids to travel through the adhesive.

Another advantage of the present disclosure includes having pores produced without environmentally hazardous, complicated, and/or expensive processing.

Yet another advantage of the present disclosure includes varying pore size in an adhesive to vary what fluids may travel through the adhesive.

Still other advantages of the present disclosure include the reproducibility, coating weight, uniformity of pore size and porosity, pore stability, and/or reduction of creep (cold flow).

Other features and advantages of the present disclosure will be apparent from the following more detailed description of the preferred embodiment, taken in conjunction with the accompanying drawings which illustrate, by way of example, the principles of the disclosure.

### BRIEF DESCRIPTION OF THE DRAWINGS

FIG. 1 illustrates a schematic representation of an embodiment of an adhesive between a first substrate and a second substrate.

FIG. 2 illustrates a schematic representation of an embodiment of an adhesive in a vertical stack of substrates.

FIG. 3 graphically shows a distribution of pore measurement of a sample according to the present disclosure.

### DETAILED DESCRIPTION

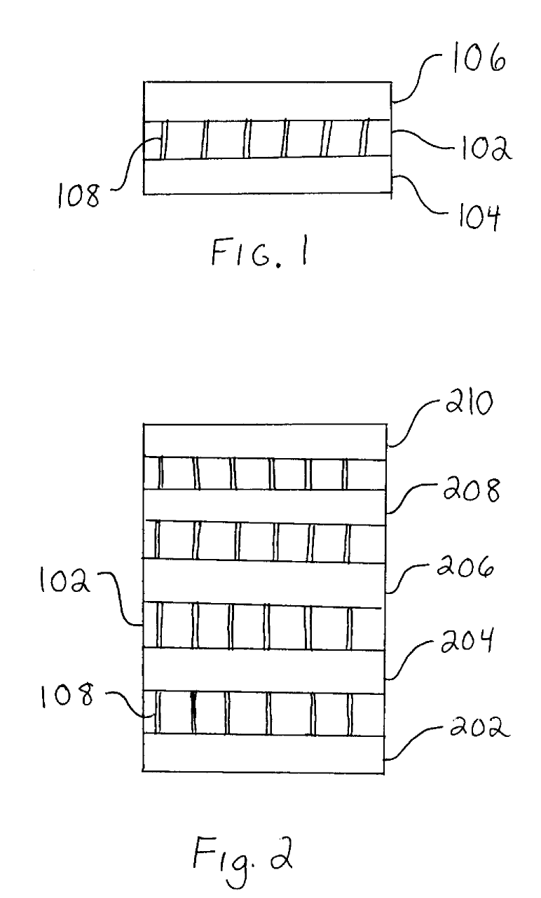

Referring to FIG. 1, an adhesive 102 includes physical and chemical features permitting fluid to travel through adhesive 102 from a first side or a first substrate 104 to a second side or a second substrate 106. The fluid travels through adhesive 102 through a plurality of pores 108 (emphasized in FIG. 1 for illustration purposes). Fluid for passage through adhesive 102 may be a gas, such as air, nitrogen, oxygen, carbon dioxide, ammonia, and water vapor or a liquid, such as blood, urine, waste water, wound exudates, saliva, buffers, etc. In the embodiment, upon being cured, adhesive 102 includes substantially uniformly distributed pores 108.

The physical processes to form the structure that permits the fluid to travel through adhesive 102 may include physical blowing agents incorporated into the adhesive prior to curing. Physical blowing agents may include, for example, volatile liquids or compressed gasses that are dissolved in a polymer and change state during processing. When physical blowing agents are included in adhesive 102, the change in state may create pores 108. Additionally or alternatively, a physical process for forming the structure that permits the fluid to travel through adhesive 102 may include whipping air. Pores 108 in adhesive 102 may be created by whipping air into a resin to be included in adhesive 102 and then curing the resin.

Other physical techniques for producing pores 108 include, but are not limited to, biaxially laser drilling adhesive 102, uniaxially stretching a film of adhesive 102, evaporation of dissolved gases in adhesive 102, incorporation of soluble particles in adhesive 102 that are subsequently dissolved, and non-continuous or inconsistent application of adhesive 102. Another physical technique includes evaporating low boiling solvent in an emulsion or solvent borne pressure sensitive adhesive. This evaporation method may be used when limited weight is desired and/or high variability of pore 108 size and pore 108 density is desired. In addition, this technique may be used for applications where pores 108 that are not open on both sides may be desired.

The chemical process permitting the fluid to travel through adhesive 102 may include incorporation of chemical blowing agents into adhesive that decompose thermally during processing to liberate gasses that form pores 108. The chemical blowing agent may be a hydrazine derivative that generate nitrogen in an exothermic reaction. These chemical blowing agents include, but are not limited to, azodicarbonamide, sulfonyl hydrazides, p-toluene semicarbazides, tetrazoles, substituted azonitrile compounds, and benzoxazines. For example, in adhesive 102 formula, the chemical blowing agent may be a volatile liquid, a carbonate, a hydrazine derivative, and/or a substituted azonitrile derivative.

Alternatively, the chemical blowing agent may be based on blends of chemical components that react to form gaseous pores. For example, blends of suitable chemical components may include inorganic carbonates and polycarbonic acids. These chemical blowing agents may result in lower gas yield thereby decreasing the size of pores 108.

Adhesives 102 including physical blowing agents and/or chemical blowing agents may have increased pore 108 stability. Such adhesives 102 may include an increased range of base polymer chemistries. In addition, such adhesives 102 may permit an increased thickness range while maintaining pore 108 stability. Generally, the formula for adhesive 102 including the blowing agent range from about 0.1% to 10% by weight in the pre-cured formula. The blowing agent decomposition temperature may be in the range of about 40° C. (about 104° F.) to about 200° C. (about 392° F.).

The properties and configuration of pores 108 may be designed for specific applications. Pore size and pore density may be controlled and/or adjusted by adhesive 102 formula, process conditions, and/or features of the substrates. Generally, adhesive 102 formula includes energy curable oligomers, monomers, fillers, tackifiers, plasiticizers, blowing agents, and/or catalysts (including initiators). For example, the formula may include acrylate oligomer, polybutadiene acrylate oligomer, polyethylene glycol acrylate oligomer, polyisoprene acrylate oligomer, and/or polyester acrylate oligomer. The formula may include a curing agent, such as, isocyanates, aziridines, difunctional and multifunctional acrylates, organometallic compounds, allyl compounds, and/or vinyl compounds. For catalysts, the formula may include photoinitiators, titanium compounds, peroxides, azo compounds, tin compounds, and platinum compounds.

Pores 108 in adhesive 102 may be altered by modifying the formula and/or physical conditions. For pressure sensitive adhesive, adhesive formula may include one or more of a polyacrylate, a polyurethane, a polybutadiene, a polyisoprene, a block polymer, a polyester, a silicone polymer, poly (alkylene oxide), and polyisobutylene.

Pores 108 may be considered microporous when they are less than about 30 Angstroms in diameter. Such microporous pores 108 may be formed, for example, by polymers with a lower cross-link density. Microporous pores 108 may be used in the diffusion of fluids, such as gasses and liquids, through adhesive 102.

Pores 108 may be considered macroporous when they are formed independent of the cross-link density. Such macroporous pores 108 may be formed, for example, by polymerization curing in the presence of porogens. Porogens include substances that are soluble in a prepolymer, but are insoluble in formed polymers. As polymerization proceeds, the spaces occupied by porogens become pores 108. Pores 108 created through this process may have a diameter of about 100 to 300 Angstroms or as large as about 2000 to 4000 Angstroms. The aggregate volume of pores 108 in adhesive 102 including macroporous pores 108 may include aggregate volumes below about 50%. When microporous pores 108 and macroporous pores 108 are included, the aggregate volume of pores 108 in adhesive 102 is generally below about 50%. The configuration and distribution of pores 108 is such that fluid is permitted to flow or otherwise pass therethrough.

Pores 108 are considered superporous when they have a diameter between about 1 and 800 micrometers. Such superporous pores 108 may be connected by macroporous pores 108 or microporous pores 108. The connection of the superporous pores 108 by the macroporous pores 108 or microporous pores 108 permits results in superporous pores 108 being in fluid communication with other superporous pores 108 sufficient to permit flow or transport of fluid. When superporous pores 108 are included in adhesive, the aggregate volume of pores 108 is generally between about 30 and 90%. Such superporous pores 108 result in highly permeable adhesive 102 with a low-density.

Adhesive 102 may be a pressure sensitive adhesive. Such a pressure sensitive adhesive may be in the form of a transfer film or a supported film. In this embodiment, pores 108 may form isolated channels extending substantially directly through adhesive 102 from first substrate 104 to second substrate 106. In another embodiment, pores 108 may form an interconnected network of channels extending in a plurality of directions but still permitting fluid to travel through adhesive 102 from first substrate 104 to second substrate 106. The inherent strength of adhesive 102 in these configurations reduces or eliminates the need for supplemental physical clamping generally required by membranes without bonding properties.

Adhesive 102 may be configured to reduce or eliminate destabilizing properties of pores 108. Adhesive 102 may reduced or eliminate destabilization of pores 108 by including materials, such as fillers, that reduce cold flow or creep. These materials reinforce the walls of pores 108 to resist deformative forces. Cold flow may result in destabilization of pores 108 when adhesive 102 thickness or coating weight is too high. The wind tension in a roll of material may induce the adhesive to flow which may cause the adhesive to flow into the pores. Cold flow becomes more pronounced at higher thicknesses because the walls of the pores must support more weight. For pressure sensitive adhesives, if pores 108 destabilize and close, the pressure sensitive adhesive may lose its functionality and/or the structure of the pressure sensitive adhesive may be compromised.

One embodiment of adhesive 102 includes a substantially solvent-free formula able to cross-link and of a viscosity adequate for application to a substrate. As will be appreciated, the viscosity is dependent upon the specific method used for applying adhesive 102. These methods include, but are not limited to, roll coating, curtain coating, spray coating, slot die coating, and dip coating. Generally, the interplay between viscosity and coating aesthetic will dictate the choice of coating technique.

In one embodiment, adhesive 102 is configured to be cured in a thermal oven that activates the blowing agent and triggers polymerization. In the embodiment, the viscosity at room temperature (about 22° C. or about 72° F.) ranges from about 1,000 to about 500,000 centipoises. Gas produced by the activation of the blowing agent may be trapped between first substrate 104 and second substrate 106 thereby beginning to form a matrix of pores 108 in adhesive 102. As more blowing agent dissociates, the matrix of pores 108 extends from first substrate 104 to second substrate 106. Adhesive 102 proximal to pores 108 and first substrate 104 or the second substrate 106 thins and thereby resulting in pores 108 that open into each other, forming a passage that permits flow of fluid. The pore formation and expansion preferably continues until fluid communication forms substantially through adhesive 102. Substantially simultaneously, adhesive 102 cures thereby stabilizing the matrix of pores 108. As will be appreciated, the amount of blowing agent and/or gas produced varies between applications and may be determined by those skilled in the art.

As will be appreciated, in other embodiments, adhesive 102 may be cured by any method of curing, depending upon the chemistry, including, but not limited to, components activated by ultraviolet light, electron beams, or catalysts.

In one embodiment of adhesive 102 may be configured to be cured by including components activated by ultraviolet light. Curing of adhesive 102 may occur after adhesive 102 forms pores 108. One example of this embodiment includes using a low boiling hydrocarbon to generate vapor which may generate bubbles ultimately leading to pore 108 formation. The generation of vapor is followed by ultraviolet light induced radical polymerization of an acrylate or methacrylate oligomer. In another embodiment, adhesive 102 may be configured to be cured by including components activated by electron beam radiation. Curing of adhesive 102 may occur after adhesive 102 forms pores 108. In yet another embodiment, adhesive 102 may be configured to be cured by including components activated by catalysts. Curing of adhesive 102 may occur after adhesive 102 forms pores 108. In still another embodiment, adhesive 102 may be configured to be cured by including components activated by solvent flash. Curing of adhesive 102 may occur while adhesive 102 forms voids thereby creating pores 108.

For biomedical applications, adhesive 102 including pores 108 may be utilized as chambers for containing liquids, growing cultures, immobilizing enzymes, growing microorganisms, chromatography, bioprocessing, drug delivery (for instance, for transdermal delivery of small and large molecule therapeutic agents), wound care (where enhanced water and exudate transmission may be desired), and medical diagnosis test kits (where a housing, which may be plastic, retains a test surface by means of a pressure sensitive adhesive). In such applications, relatively uniform size of pores 108 may be additionally beneficial.

Adhesive 102 may be included in a vertical stack of substrates with adhesive 102 between each substrate. For example, as illustrated in FIG. 2, the substrates may be stacked with adhesive 102 between each substrate such as an absorbent pad 202, an indicator reagent medium 204, a capture reagent medium 206, a filtration of red blood cells 208, and a sample pad 210. In other embodiments, substrates may be oriented horizontally with adhesive between the substrates. In yet other embodiments, the vertical flow stack could be placed on a traditional horizontal flow device to extend the flow path.

Referring again to FIG. 1, applications that may use adhesive 102 including pores 108 involve first substrate 104 and/or second substrate 106 being used in constructing a stack of filtration membranes. In these applications, it is preferable that pores 108 permit fluid to travel from first substrate 104 to second substrate 106 at a rate equal to or faster than the rate fluid would travel through the substrates.

Yet another application that may use adhesive 102 including pores 108 is high moisture vapor transmission. High moisture vapor transmission may be desirable in bandages, cover slips, for permitting exchange of oxygen and carbon dioxide, and/or culture dishes. In these cases, the adhesive may be placed in contact with the wound on one side and bonded to an absorbent pad on the other side. The porous adhesive would hold the pad in place and allow for the transport of wound exudates through the pores into the absorbent pad. The construction of a device such as this may be varied to include a perimeter adhesive, antimicrobial, indicating reagents, as well as various backing layers or overlays. One skilled in the art of wound management device design will see the benefit of allowing liquid flow away from the wound while maintaining the ability to bond various layers together.

Yet another application that may use adhesive 102 including pores 108 is a transdermal drug delivery device. Adhesive 102 may be used for several functions within the transdermal drug delivery device. Pores 108 may act as reservoir to hold the drug and optionally any plasticizers, stabilizers, enhancers, or antimicrobials. In one embodiment, adhesive 102 may be used in a layer between the skin and the drug reservoir. This may maintain the drug reservoir in intimate contact with the skin thereby allowing for a more uniform drug flux through the skin. Adhesive 102 may also be used in a transdermal device to bond layers within the device together while still allowing flux of active ingredients between layers.

Still another application that may use adhesive 102 including pores 108 is breathable fabrics as first substrate 104 and/or second substrate 106. Producing fabrics with several layers reduces the ability for a fluid to travel through the fabric. When non-porous adhesives are included between the layers of fabric, fluids are substantially, if not entirely, impeded from traveling through the fabric. Using adhesive 102 including pores 108 permits the flow or transport of water vapor through the adhesive and between the layers of fabric.

Still yet another embodiment that may use adhesive 102 with pores 108 includes applications where containing a liquid but venting a gas is desired. One such example is in the production of microfluidic devices. Other applications that may use adhesive 102 include, but are not limited to, filling pores 108 with ionically conductive hydrogels for biomapping, filling pores 108 with molecularly imprinted polymers for selective filters, filling pores 108 with reagents, and/or filling pores with electrically conductive or other materials for electrical connections. Additionally or alternatively, adhesive 102 may be made from dissolvable or erodible components (for example, permitting adhesive 102 to dissolve in solvents with certain polarity but resist other solvents). Additionally, adhesive 102 may include antifoams, may include surfactants, and/or may include leveling agents to modify pore 108 structure.

As will be appreciated, numerous other applications relating to films may use adhesive 102 including pores 108. The above applications and the other applications may use adhesive including pores 108 as a transfer film coated between two release layers or as a double-sided porous adhesive supported film that is coated between release liners separated by a non-woven material, mesh or other permeable substrate. Such films may include features desired for specific applications. For instance, such films may include be non-tacky and/or may be of differing sizes or thickness.

For forming an adhesive tape, a homogenous solution of adhesive 102 in its form prior to being cured may be cast into a film. The adhesive tape may include any and/or all features of the adhesive 102. Upon being cast, the film may be laminated. In one embodiment, the adhesive tape may be cured in any manner described above to produce adhesive 102 having pores 108. In another embodiment, the adhesive tape may be cured in any manner described above after producing pores 108. In yet another embodiment, the adhesive tape may be prepared by coating and curing adhesive 102 on a flexible web. A flexible web includes, but is not limited to, films such as polyester, polyurethane, polyethylene, nylon, poly (vinylidiene fluoride), cellulose, nitrocellulose, and/or polyethersulfone. A flexible web may also including, but not be limited to, foam such as those based on polyethylene and/or polyurethane. A flexible web may be nonwoven material including, but not limited to, cellulose and/or fiberglass. In still another embodiment, the adhesive tape may be configured to be hydrophobic. In still yet another embodiment, the adhesive tape may be configured to be hydrophilic. In another embodiment, the adhesive tape may be configured to be oleophobic. The formation of tape permits easy transport and application of the adhesive system to a variety of locations and substrates. The adhesive may form instant bonds to join film substrates, membranes, pads, filter elements, or plastic parts without the need for curing or clamping during production of the finished product. Another advantage of the adhesive tape may be that it allows for roll-to-roll manufacturing of devices and simplifies manipulation of small die-cut multi-laminate structures. The porous adhesive may provide a physical separation and bonding layer between materials while enabling the rapid passage of fluid through the adhesive.

### EXAMPLES

In a substantially clean vessel, 90 parts of high molecular weight aliphatic polyether urethane acrylate (BR 3641AB from Bomar Specialties Co. of Torrington, Conn.), 10 parts aliphatic polyether urethane acrylate (BR 3731 from Bomar Specialties Co.), 30 parts polypropylene glycol monoacrylate (Bisomer PPA6 from Cognis Corporation of Ambler, Pa.), and 1.3 parts VAZO 52 (from E.I. du Pont de Nemours and Company of Wilmington, Del.) were mixed. The mixture was then coated on siliconized release liners using a coating station to a thickness of about 1.0 mils. (about 1/1000 inches). The coated film was then laminated with a siliconized release liner with a slightly higher release, and placed in an oven at about 150° C. (about 302° F.) for 3 minutes, resulting in a tacky pressure sensitive porous adhesive with a thickness of about 4.0 mils. (about 4/1000 inches).

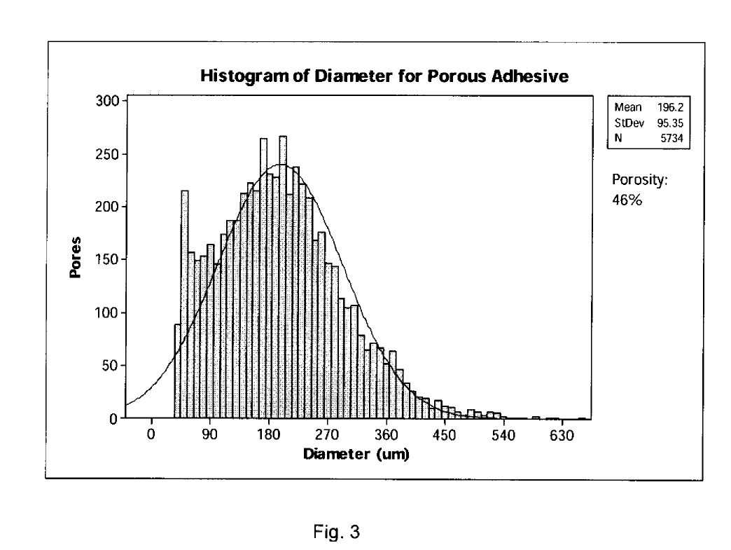

The porosity of the sample was determined using an optical microscope equipped with measurement software capable of counting the number of pores, pore diameter, pore area, and percent pore area or porosity. FIG. 3 shows the pore diameters of the sample as well as the average diameter, and porosity.

The fluid penetration time was also tested to determine if the pores were open for fluid transport. The porous adhesive was laminated to an absorbent pad and red dye water was then placed on the porous adhesive and observations were made of the time for water to penetrate the pores. Pores were designed where penetration time was under one second and higher.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A pressure sensitive adhesive comprising:
a substantially continuous polymer phase having pressure sensitive adhesive properties; and
a plurality of pores arranged within the substantially continuous polymer phase and disposed to permit fluid to pass from a first side through at least a portion of the plurality of pores to a second side; and
wherein the plurality of pores is substantially resistant to cold flow.

2. The pressure sensitive adhesive of claim 1, wherein the plurality of pores is produced by a physical blowing agent or chemical blowing agent.

3. The pressure sensitive adhesive of claim 1, wherein the pores in the plurality of pores are one or more of microporous, macroporous, and superporous.

4. The pressure sensitive adhesive of claim 1, wherein the pores are substantially uniform.

5. The pressure sensitive adhesive of claim 1, comprising a curable continuous polymer phase and a blowing agent.

6. The pressure sensitive adhesive of claim 5, further comprising an additive selected from the group consisting of oligomer, tackifying resin, plasticizer, filler, curing agent, catalysts, and combinations thereof.

7. The pressure sensitive adhesive of claim 5, wherein the substantially continuous polymer phase is selected from the group consisting of a polyacrylate, a polyurethane, a polybutadiene, a polyisoprene, a block polymer, a polyester, a silicone polymer poly (alkylene oxide), a polyisobutylene, and combinations thereof.

8. The pressure sensitive adhesive of claim 5, wherein the continuous polymer phase is selected from the group consisting of an urethane acrylate oligomer, a polybutadiene acrylate oligomer, a polyethylene glycol acrylate oligomer, a polyisoprene acrylate oligomer, a polyester acrylate oligomer, and combinations thereof.

9. The pressure sensitive adhesive of claim 5, wherein the blowing agent is selected from the group consisting of an azodicarbonamide, sulfonyl hydrazides, p-toluene semicarbazides, tetrazoles, substituted azonitrile compounds, benzoxazines, carbonates, hydrazine derivatives, and combinations thereof.

10. The pressure sensitive adhesive of claim 5, wherein the blowing agent is a volatile liquid.

11. The pressure sensitive adhesive of claim 6, wherein the curing agents is selected from the group consisting of an isocyanate, an aziridine, a difunctional acrylate, a multifunctional acrylate, an organometallic compound, an allyl compound, a vinyl compound, and combinations thereof.

12. The pressure sensitive adhesive of claim 6, wherein the catalyst is selected from the group consisting of a photoinititiator, a titanium compound, a peroxide, an azo compound, a tin compound, a platinum compound, and combinations thereof.

13. A method of forming a porous pressure sensitive adhesive tape comprising:
providing a solution for forming an adhesive having pressure sensitive adhesive properties, the solution including a pore forming material;
casting a film comprising the solution;
laminating a liner on the film;
exposing the adhesive to an energy source to form pores in the adhesive and cure the adhesive to form the pressure sensitive adhesive tape.

14. The method of claim 13, wherein the energy source is selected from the group consisting of a thermal energy source, an ultraviolet light energy source, an electron beam energy source and combinations thereof.

15. The method of claim 13, further comprising coating and curing the pressure sensitive adhesive tape on a flexible web.

16. The method of claim 13, wherein the tape is arranged and disposed to permit fluid to travel from a first side through at least a portion of a plurality of pores to a second side.

17. The method of claim 13, further comprising coating and curing the pressure sensitive adhesive tape.

18. The method of claim 17, further comprising providing ionically conductive hydrogels to one or more of the plurality of pores.

19. The method of claim 17, further comprising providing molecularly imprinted polymers to one or more of the plurality of pores.

20. The method of claim 17, further comprising providing reagents to one or more of the plurality of pores.

21. The method of claim 17, further comprising providing electrically conductive materials to one or more of the plurality of pores.

22. The method of claim 17, further comprising modifying the plurality of pores by adding components to the adhesive selected from the group consisting of an antifoamer, a surfactant, a leveling agent, and combinations thereof.

23. The method of claim 13, wherein the adhesive contains hydrophilic components.

24. The method of claim 13, wherein the porous pressure sensitive adhesive tape is disposed within a medical diagnostic testing device.

25. The method of claim 13, wherein the film is substantially devoid of tackiness.

26. The method of claim 13, further comprising treating a wound by placing the pressure sensitive adhesive tape on the wound.

27. The method of claim 13, wherein the porous pressure sensitive adhesive tape is disposed in a vertical flow device.

28. The method of claim 13, wherein the porous pressure sensitive adhesive tape is disposed intermediate layers of filters.

29. The method of claim 13, further comprising bonding membranes with the porous pressure sensitive adhesive tape.

30. The method of claim 29, wherein gasses may be vented while preventing other fluids from traveling through the membranes.

31. The method of claim 13, further comprising placing the porous pressure sensitive adhesive tape between a drug reservoir and skin.
